(19) United States
(12) Patent Application Publication
(10) Pub. No.: US 2019/0049884 A1
(43) Pub. Date: Feb. 14, 2019

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Masato OGASAWARA, Katsushika Tokyo (JP)

(21) Appl. No.: 15/941,183

(22) Filed: Mar. 30, 2018

(30) Foreign Application Priority Data
Aug. 10, 2017 (JP) 2017-155759

(51) Int. Cl. G03G 15/00

(52) U.S. Cl. CPC G03G 15/5008; G03G 15/052; G03G 2215/1661; G03G 15/161; G03G 15/5029

(57) ABSTRACT

In accordance with an embodiment, an image forming apparatus includes an operation section configured to receive instruction information specifying a print media, a printer section configured to drive an image carrier, the printer section including the image carrier on which an image including a developing agent to be transferred to a print media may be formed, the image carrier drivable through a transfer section wherein the image is transferred to a print media, and a processing unit configured to determine driving information indicating a driving mode of the image carrier for carrying a developing agent, wherein the driving mode includes a mode where additional driving of the image carrier after transferring an image therefrom is performed after an ordinary image form, and control the printer section to further drive the image carrier, after transferring the developing agent onto the print media, by additionally driving the image carrier.

### CROSS-REFERENCE TO RELATED APPLICATION

This application is based upon and claims the benefit of priority from Japanese Patent Application no. 2017-155759, filed Aug. 10, 2017, the entire contents of which are incorporated herein by reference.

### FIELD

Embodiments described herein relate generally to an image forming apparatus and an image forming method.

### BACKGROUND

In recent years, an image forming apparatus prints on a variety of sheets such as a label paper, a sheet having a coating on a surface thereof and the like, in addition to printing on a normal sheet. However, in a case in which the sheet is label paper including an adhesive layer, if heat or pressure is applied to the label paper, there is a case in which the adhesive of the adhesive layer adheres to an image carrier, a fixing device or a conveyance path. The adhesive is not sufficiently removed therefrom by a cleaner section which removes toner remaining on the image carrier. Thus, there is a case in which a cleaning defect is caused, which leads to problems such as a conveyance defect and image degradation on subsequently printed sheets.

### DESCRIPTION OF THE DRAWINGS

FIG. 1 is an external view illustrating an example of an image forming apparatus according to an embodiment;

FIG. 2 is a diagram illustrating an example of a label paper construct;

FIG. 3 is a diagram illustrating an example of a label paper having a slit;

FIG. 4 is a functional block diagram illustrating the image forming apparatus according to the embodiment;

FIG. 5 is a diagram illustrating an example of the inside of a printer section according to the embodiment;

FIG. 6 is a flowchart illustrating the flow of removal of an adhesive according to the embodiment; and

FIG. 7 is a diagram illustrating an example of an inside of a printer section of a monochrome image forming apparatus.

### DETAILED DESCRIPTION

In accordance with an embodiment, an image forming apparatus includes an operation section configured to receive instruction information specifying a type of print media on which a visible image is to be formed, a printer section configured to drive an image carrier, the printer section including an image carrier on which an image including a developing agent to be transferred to a print media may be formed, the image carrier drivable through a transfer section wherein the image is transferred to a print media, and a processing unit configured to determine driving information indicating a driving mode of the image carrier for carrying a developing agent to be transferred onto the print media on the basis of the instruction information, wherein the driving mode includes at least a first mode wherein no additional driving of the image carrier after transferring an image therefrom is performed, and a second mode where additional driving of the image carrier after transferring an image therefrom is performed and control the printer section to further drive the image carrier, after transferring the developing agent onto the print media, by additionally driving the image carrier when the mode is the second mode.

Hereinafter, an image forming apparatus and an image forming method according to an embodiment are described with reference to the accompanying drawings.

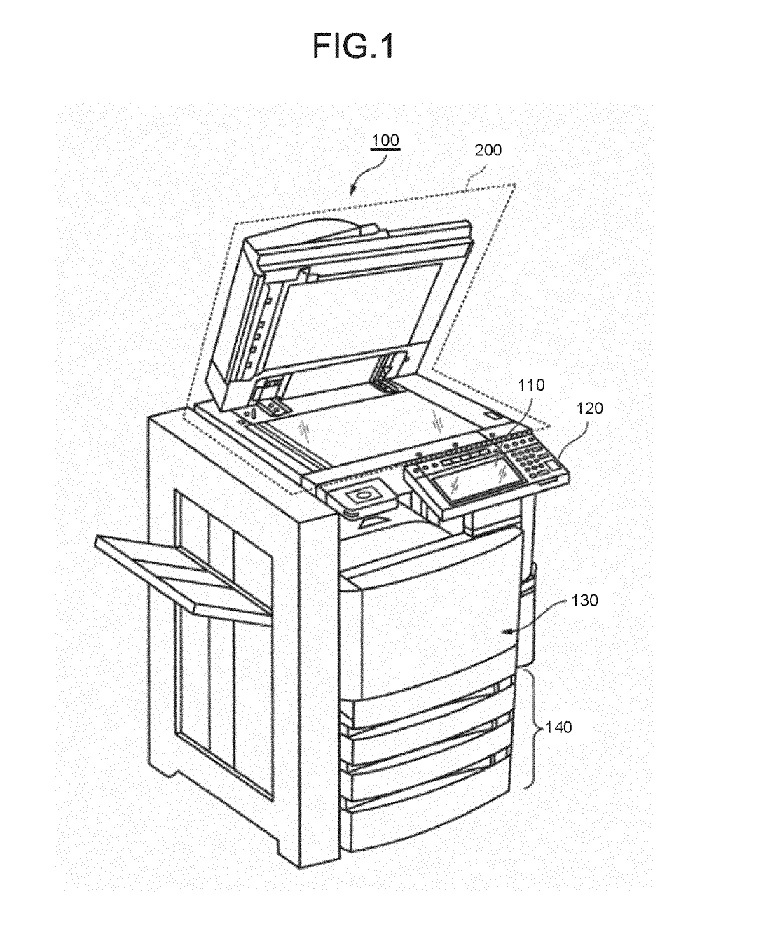

FIG. 1 is an external view illustrating an example of an image forming apparatus 100 according to the embodiment. The image forming apparatus 100 is, for example, an MFP (Multifunction Peripheral). The image forming apparatus 100 includes a display 110, a control panel 120, a printer section 130, a sheet housing section 140 and an image reading section 200. Furthermore, the printer section 130 of the image forming apparatus 100 may be a device for fixing a toner image.

The image forming apparatus 100 forms an image on a sheet with a developing agent such as toner. The sheet is, for example, a paper or a label paper, but not limited thereto as long as the image forming apparatus 100 can form an image on the surface of the sheet.

The display 110 is an image display device such as a liquid crystal display, an organic EL (Electro Luminescence) display and the like. The display 110 displays various kinds of information relating to the image forming apparatus 100.

The control panel 120 includes a plurality of buttons. The control panel 120 receives an operation of a user. The control panel 120 outputs a signal corresponding to an operation carried out by the user to a control section of the image forming apparatus 100. Furthermore, the display 110 and the control panel 120 may be independent physical entities or both may be integrated into a single touch panel. The control panel 120 is one example of an operation section.

The printer section 130 forms an image on a sheet on the basis of image information generated by the image reading section 200 or image information received via a communication path. The printer section 130 forms the image by, for example, the following processing. The image forming section of the printer section 130 forms an electrostatic latent image on a photoconductive drum on the basis of the image information. The image forming section of the printer section 130 enables a developing agent to adhere to the electrostatic latent image to form a visible image on the drum. As a concrete example of the developing agent, toner is exemplified. The transfer section of the printer section 130, for example a belt onto which a negative image of the image has been transferred from the roller, transfers the visible image onto the sheet. The fixing section of the printer section 130 heats and presses the sheet, typically at a pinch between two rollers and the transfer section to enable the developing agent forming the visible image to be fixed on the sheet. The sheet on which the image is formed may be a sheet drawn from the sheet housing section 140 or a manually fed sheet.

The sheet housing section 140 houses a sheet, used for image formation thereon by the printer section 130. The sheet housing section 140 includes a plurality of trays for housing sheets. The sheet housing section 140 includes, for example, a first tray, a second tray and a third tray. Papers of A4 size may be stored in the first tray, papers of A3 size may be stored in the second tray, and the label papers may be stored in the third tray. Other paper sizes, such as letter and legal size may be located in the first and second trays.

The image reading section 200 reads the image information of a read object based on the differences in the intensity of light reflected therefrom. The image reading section 200 records the read image information. Then, the image information may be sent to another information processing apparatus via a network. The image information may be used for the image formation on the sheet fed through the printer section 130.

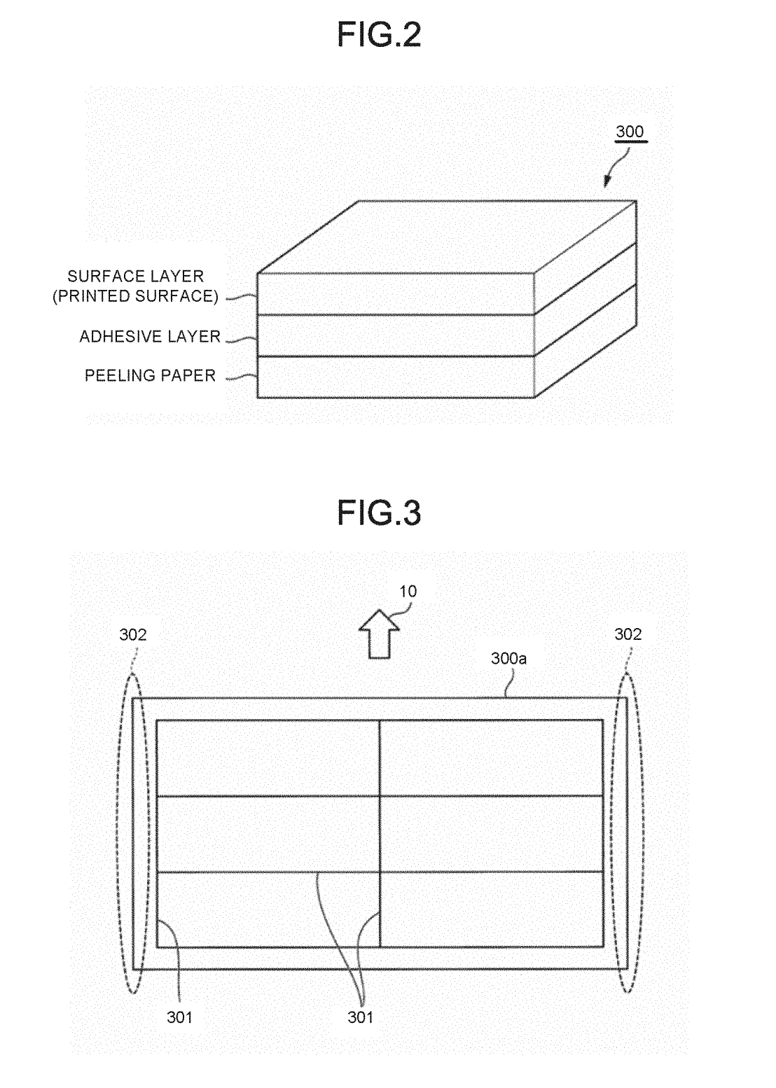

FIG. 2 is a diagram illustrating an example of a label paper 300. The label paper 300 includes a peeling paper, an adhesive layer and a surface layer which is a covering sheet. The label paper 300 is used in such a manner that the surface layer and the adhesive layer are peeled off from the peeling paper after an image has been printed thereon. The surface layer is a printed surface of the label paper 300. The adhesive layer is an adhesive. The adhesive layer adheres to an object contacted therewith after the peeling paper is peeled from the surface layer. When pressure is applied to the adhesive layer, there is a case in which the adhesive leaks out from the edge portion of the label paper, or where a seam, such as a slit 301, extends through the surface layer. The adhesive is, for example, glue.

FIG. 3 is a diagram illustrating an example of a label paper 300a having a slit. The label paper 300a shown in FIG. 3 has a slit 301 in the surface layer. The surface layer and the adhesive layer of the label paper 300a are peeled off from each slit 301. The label paper 300a is conveyed for printing thereon, for example, in a direction of the arrow 10. The adhesive of the adhesive layer leaks out from an end portion and the slit 301 of the label paper 300a. In particular, in a case in which the label paper 300a is conveyed in the direction indicated by the arrow 10, there is a case in which more adhesive leaks out from the end portion 302 than from other locations thereof. Hereinafter, when the label paper 300 and the label paper 300a are not distinguished, they are simply referred to as the label paper and described.

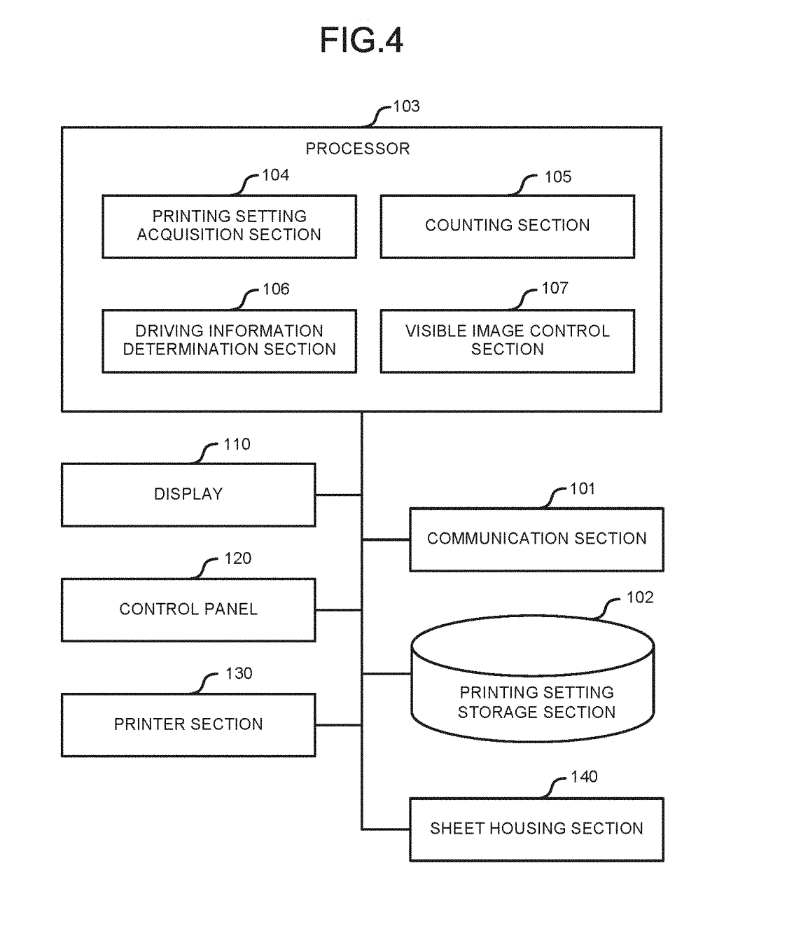

FIG. 4 is a functional block diagram illustrating the image forming apparatus 100 according to the embodiment. The image forming apparatus 100 includes a communication section 101, a printing setting storage section 102, a processor 103, the display 110, the control panel 120, the printer section 130 and the sheet housing section 140.

The communication section 101 is a network interface. The communication section 101 communicates with an external terminal via a network. The communication section 101 may carry out communication using, for example, a wireless LAN (Local Area Network), a wired LAN, Bluetooth® or LTE® (Long Term Evolution) and the like. The external terminal is an information processing apparatus such as a personal computer, a tablet computer, a smart phone or server.

The printing setting storage section 102 is configured in a storage device such as a magnetic hard disk device or a semiconductor storage device. The printing setting storage section 102 stores printing setting information. The printing setting information is information for setting of the printer section 130 in a case in which the image is formed on the sheet such as the paper or the label paper. The printing setting information includes, for example, information such as sheet information, a driving distance of an image carrier, driving time of the image carrier, a driving speed of the image carrier, rotational speeds of various rollers, a tray of the sheet housing section 140 and the like. The image carrier carries the developing agent to be transferred onto the sheet. The image carrier may be, for example, an intermediate transfer belt or a photoconductive drum. The sheet information is information indicating whether the sheet is the paper or the label paper, or information relating to the sheet such as the size of the sheet. The printing setting storage section 102 stores the printing setting information for each tray of the sheet housing section 140. In a case in which the sheet is the label paper, the printing setting information includes a driving distance of the image carrier longer, i.e., a greater distance, than the driving distance for just transferring the developing agent onto the label paper stored therein as the driving distance of the image carrier. In a case in which the sheet is the label paper, the printing setting information may include a setting in which the developing agent is added to the image carrier at the location thereon of the just transferred image or after the image transfer has been completed or to the end portion or to the slit of the label paper. Additionally, where a label paper is to be printed upon, the additional developing agent may be applied to the image on the image carrier before that image is transferred to a sheet, such as by adding additional developing agent to the image when it is formed on the image carrier.

The processor 103 controls the operations of each section of the image forming apparatus 100. The processor 103 is executed by a device including, for example, a CPU (Central Processing Unit) for controlling the entire device and a RAM (Random Access Memory). The processor 103 functions as a printing setting acquisition section 104, a counting section 105, a driving information determination section 106 and a visible image control section 107 by executing an image forming program.

The printing setting acquisition section 104 acquires the printing setting information from the printing setting storage section 102 on the basis of instruction information. The instruction information is specified by being chosen from a plurality of items of printing setting information. The instruction information may include a sheet type or a tray number of the sheet housing section 140. The instruction information may be received from the control panel 120, or may be received from an external terminal via the communication section 101.

The counting section 105 counts the number of sheets printed for each type of sheet. The driving information determination section 106 determines driving information. The driving information indicates how the image carrier should be driven on the basis of the printing setting information. The printer section 130 drives the image carrier on the basis of the determined driving information. The driving information may include, for example, the driving distance to drive, i.e., move, the image carrier, the driving time for driving the image carrier, or the driving speed of the image carrier.

The visible image control section 107 adds the developing agent to the image carrier on the basis of the read image information or the image information received from the external terminal. The visible image control section 107 determines whether or not the sheet onto which the developing agent is transferred is the label paper on the basis of the printing setting information. In a case in which the developing agent is transferred onto the label paper, the visible image control section 107 further adds the developing agent onto the image carrier.

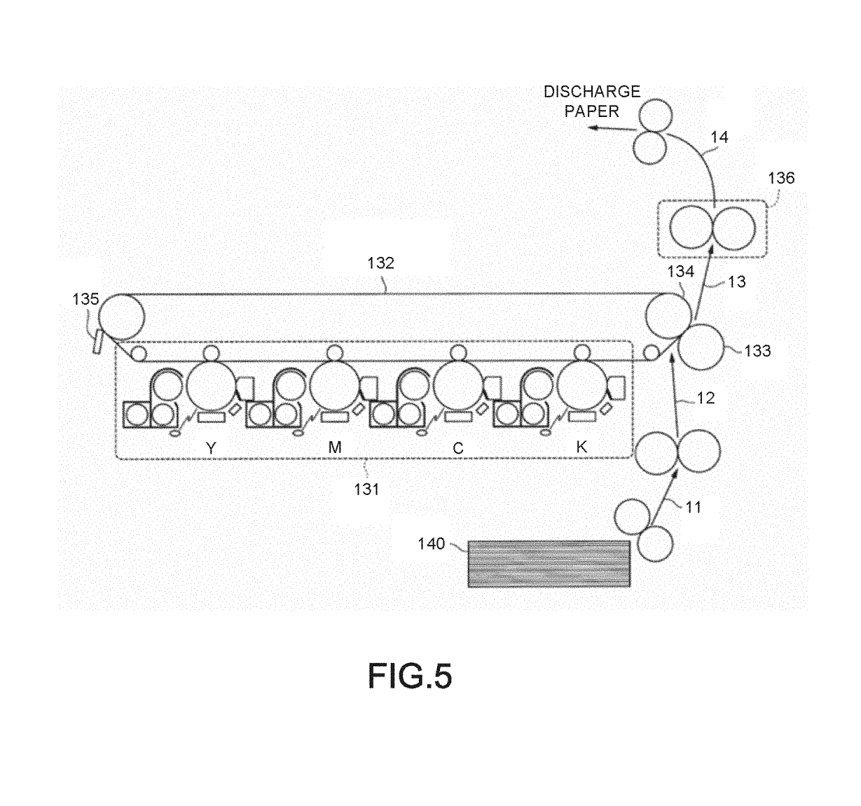

FIG. 5 is a diagram illustrating an example of the inside of the printer section 130 according to the embodiment. The printer section 130 includes a visible image forming section 131, an image carrier 132, a secondary transfer roller 133, a secondary transfer opposite roller 134, an image carrier cleaner 135 and a fixing section 136. An arrow 11, an arrow 12, an arrow 13 and an arrow 14 indicate the conveyance route of the sheet. The printer section 130 determines a tray, from which to draw out a sheet for printing thereon, from those present in the sheet housing section 140 on the basis of the instruction information. The printer section 130 conveys the sheet from the tray of the sheet housing section 140. The sheet is conveyed along the conveyance route from the arrow 11 to the arrow 14, and discharged to the outside of the image forming apparatus 100.

The visible image forming section 131 forms a visible image by adding the developing agent to the image carrier 132. The printer section 130 transfers the applied developing agent onto the sheet passing through a position between the secondary transfer roller 133 and the secondary transfer opposite roller 134 by driving, i.e., moving, the image carrier 132. The transferred sheet is then conveyed to the fixing section 136. The developing agent remaining on the image carrier 132 is removed by the image carrier cleaner 135. The image carrier cleaner 135 includes a cleaning blade made of elastic rubber such as urethane and a toner conveyance section for conveying the developing agent removed from the image carrier 132 to a container.

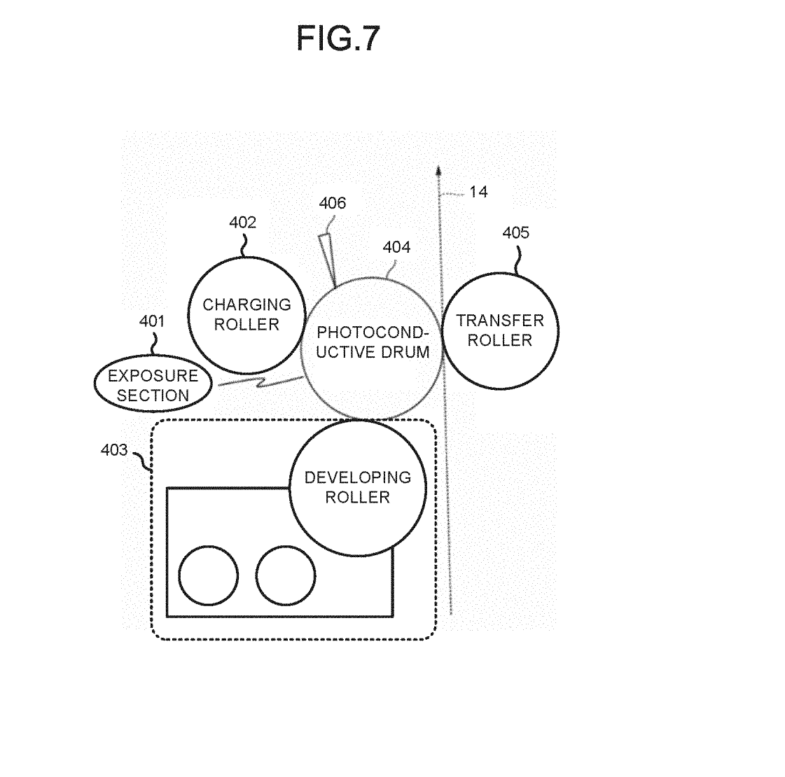

In a case in which the sheet passing through a position between the secondary transfer roller 133 and the secondary transfer opposite roller 134 is the label paper, the adhesive leaks out from the label paper to adhere to the image carrier 132. There is a case in which the adhesive adhering to the image carrier 132 is not removed by the image carrier cleaner 135. The printer section 130 determines whether or not the sheet onto which the developing agent is transferred is the label paper on the basis of the sheet information included in the printing setting information. In a case in which the developing agent is transferred onto the label paper, the printer section 130 sets the driving distance of the image carrier 132 to be a distance longer than the driving distance necessary to simply transfer the developing agent onto the label paper, in order to remove the adhesive adhering to the image carrier 132. In other words, the printer section 130 makes a determination to extend and drive the image carrier 132 such that the driving distance is longer than that in a case in which the sheet is not the label paper. It is desirable that adhesive strength of the adhesive adhering to the image carrier 132 is decreased by applying the developing agent to the adhesive adhering to the image carrier 132, and the adhesive is then easily removed from the image carrier 132 by the image carrier cleaner 135. A bias voltage is applied to each of a charging roller 402 and a developing device 403 as shown in FIG. 7, and the developing agent adheres to the image carrier 132 through the visible image forming section 131. This developing agent is not transferred onto the sheet. Otherwise, at the time the image carrier is extended and driven, the application of the bias voltage of the charging roller 402 and the developing device 403 is stopped, the developing agent may adhere to the image carrier

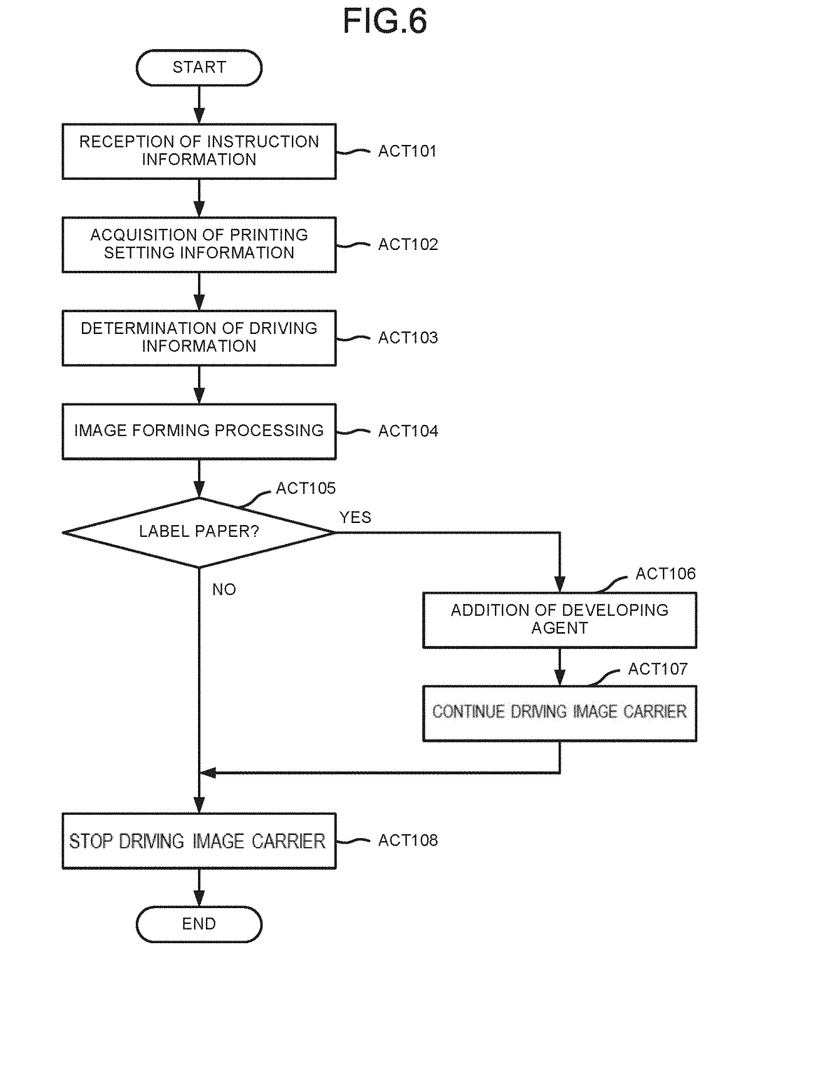

FIG. 6 is a flowchart illustrating the adhesive removal process according to the embodiment. The control panel 120 of the image forming apparatus 100 receives the instruction information from the user (ACT 101). The printing setting acquisition section 104 acquires the printing setting information on the basis of the instruction information (ACT 102). The driving information determination section 106 determines the driving information of the image carrier 132 on the basis of the printing setting information (ACT 103). The printer section 130 forms the image on the sheet (ACT 104).

The visible image control section 107 determines whether or not the sheet on which the image is formed is the label paper (ACT 105). Specifically, the visible image control section 107 determines whether or not the sheet information included in the printing setting information is the label paper. In a case in which the sheet on which the image is formed is not the label paper (NO in ACT 105), which is a first driving mode, the adhesive removal processing is ended. In a case in which the sheet on which the image is formed is the label paper (YES in ACT 105), the visible image control section 107 adds the developing agent onto the image carrier 132 (ACT 106). The printer section 130 then additionally or further drives or moves the image carrier 132 an additionally distance or additional period of time, if the sheet is label paper (ACT 107), which is a second driving mode. The printer section 130 then stops the driving of the image carrier 132 (ACT 108).

### Effects

In a case in which the developing agent is transferred onto the label paper, the driving information determination section 106 determines the driving distance of the image carrier 132 to be a distance longer than the driving distance required to transfer the developing agent onto the label paper. The printer section 130 drives, i.e., moves, the image carrier 132 depending on the determined driving distance. The image carrier 132 is also further driven after the developing agent is transferred onto the label paper. Thus, the developing agent and the adhesive adhering to the image carrier 132 which leaks out from the label paper are removed by the image carrier cleaner 135. Further, the visible image control section 107 may cause the additional developing agent to be added onto the image carrier 132 after the developing agent of the image is transferred onto the label paper. The adhesive adhering to the image carrier 132 is coated by the added developing agent. Since the adhesive strength of the adhesive to the image carrier 132, once coated by the developing agent, is decreased, the image carrier cleaner 135 can remove the developing agent from the image carrier 133 more reliably.

### Modification

The driving information determination section 106 may determine to extend the driving distance of the image carrier 132 only when the total number of label sheets exceeds a threshold value. This is because if the image carrier 132 is driven longer each time the label sheet is printed, the lifetime of the image carrier 132 becomes shorter. Further, the time consumed for the printing processing and the amount of the developing agent for coating the adhesive are increased. Thus, the image carrier 132 is not driven longer each time but only when the cumulative number of the label sheets exceeds the threshold value. In addition, after the image carrier 132 is driven longer upon meeting the condition, the number of sheets counted by the counting section 105 is reset to zero. With this modified driving information determination section 106, the time required for the printing processing can be shortened, and the amount of the developing agent used for covering and removing the adhesive can be saved.

The visible image control section 107 may add the developing agent to locations where the adhesive leaks out from the label paper in addition to adding the developing agent onto the image carrier 132 depending on the image information. Specifically, the visible image control section 107 adds the developing agent to the end portion or the slit of the label paper where they will engage with the image carrier 132 during the transfer of the image to the label paper. It is desirable that the added developing agent is, for example, an invisible developing agent. The invisible developing agent is, for example, transparent toner or decolorable toner. The transparent toner is colorless toner having no color. The decolorable toner does not generate a color at a temperature greater than or equal to a predetermined temperature and remains decolored. In this way, since the developing agent is added to the label paper, it becomes difficult for the adhesive to adhere to the image carrier 132, and it remains on the sheet when the image is printed on the sheet. Thus, it is possible to prevent the adhesive from being accumulated to the image carrier cleaner 135.

The present embodiment may be applied to a monochrome image forming apparatus. FIG. 7 is a diagram illustrating an example of an inside of a printer section of a monochrome image forming apparatus. The printer section of the monochrome image forming apparatus includes an exposure section 401, the charging roller 402, the developing device 403, a photoconductive drum 404, a transfer roller 405 and a photoconductor cleaner 406. An arrow 14 is a conveyance direction of the label paper.

In the monochrome image forming apparatus, the exposure section 401, the charging roller 402 and the developing device 403 function as the visible image forming section 131 according to the embodiment. In the monochrome image forming apparatus, the photoconductive drum 404 functions as the image carrier 132 according to the embodiment. In the monochrome image forming apparatus, the transfer roller 405 functions as the secondary transfer roller 133. The photoconductor cleaner 406 functions as the image carrier cleaner 135.

In the monochrome image forming apparatus, the adhesive leaking out from the label paper adheres to the photoconductive drum 404. Thus, in a case in which the developing agent is transferred onto the label paper, the printer section drives, i.e., rotates, the photoconductive drum 404 more than that needed to just transfer the image to a sheet. The developing device 403 adds the developing agent onto the photoconductive drum 404 after the label paper is conveyed to the fixing section, i.e., after the image is transferred to the sheet. The adhesive adhering to the photoconductive drum 404 is coated by the added developing agent. The adhesive strength of the adhesive, once coated by the developing agent, decreases. The photoconductor cleaner 406 removes the developing agent of which the adhesive strength of attachment of the sheet is decreased. With such a constitution, even in the monochrome image forming apparatus, the adhesive can be removed.

In each embodiment described above, the driving information determination section 106 and the visible image control section 107 are software-based function; however, they may be hardware-based functions such as an LSI device.

According to at least one embodiment described above, the adhesive adhering to the image carrier 132 can be removed by using the driving information determination section 106 to selectively extend the driving time or length of the image carrier 132 to enable adhesive adhered thereto to be removed.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
an operation section configured to receive instruction information specifying a type of print media on which a visible image is to be formed;
a printer section configured to drive an image carrier, the printer section including the image carrier on which an image including a developing agent to be transferred to a print media may be formed, the image carrier drivable through a transfer section wherein the image is transferred to a print media; and
a processing unit configured to:
determine driving information indicating a driving mode of the image carrier for carrying a developing agent to be transferred onto the print media on the basis of the instruction information, wherein the driving mode includes at least a first mode wherein no additional driving of the image carrier after transferring an image therefrom is performed, and a second mode where additional driving of the image carrier after transferring an image therefrom is performed; and
control the printer section to further drive the image carrier, after transferring the developing agent onto the print media, by additionally driving the image carrier when the mode is the second mode.

2. The image forming apparatus according to claim 1, wherein:
the processing unit is further configured to additionally drive the image carrier after the developing agent is transferred onto the print media when the print media has an adhesive thereon.

3. The image forming apparatus according to claim 1, further comprising:
a storage device that stores printing setting information for print media, and the instruction information output by the operation section is determined based on the printing setting information for a selected print media.

4. The image forming apparatus according to claim 3, wherein the printing setting information includes at least type of print media information, a driving distance of an image carrier for the type of print media, driving time of the image carrier for the type of print media, a driving speed of the image carrier and the type of print media in a tray of the sheet housing section.

5. The image forming apparatus according to claim 1, further comprising:
an image carrier cleaner, the image carrier cleaner comprising a cleaning blade and a toner conveyance section and a container.

6. The image forming apparatus according to claim 2, further comprising:
a counting section configured to count a cumulative number of print media having an adhesive surface printed in the image forming apparatus, wherein the processing unit is configured to:
drive the image carrier a distance greater than that required to transfer an image from the image carrier to a print media after the developing agent is transferred onto the print media when the cumulative number is equal to a preset number

7. The image forming apparatus according to claim 1, wherein the developing agent is transparent toner or decolorable toner.

8. An image forming apparatus at least having a transparent toner, comprising:
an operation section configured to receive instruction information specifying a print media on which a visible image is to be formed;
a printer section configured to drive an image carrier;
a processing unit configured to:
determine driving information indicating a driving mode of the image carrier for carrying a developing agent to be transferred onto the print media based on the instruction information, wherein if the print media is a label paper with a peelable backing paper having a slit therein, the driving mode includes adding the transparent toner to the slit during, or after, transferring an image onto the print media.

9. The image forming apparatus according to claim 8, further comprising:
a storage device that stores printing setting information for print media, and the instruction information output by the operation section is determined based on the printing setting information for a selected print media.

10. The image forming apparatus according to claim 8, wherein the printing setting information includes at least print media information, a driving distance of an image carrier based on the type of print media, driving time of the image carrier based on the type of print media, a driving speed of the image carrier, rotational speeds of various rollers, and the type of print media in tray of the sheet housing section.

11. The image forming apparatus according to claim 8, further comprising:
an image carrier cleaner, the image carrier cleaner comprising a cleaning blade and a toner conveyance section and a container.

12. The image forming apparatus according to claim 8, wherein:
the driving information indicating a driving mode of the image carrier for carrying a developing agent to be transferred onto the print media further includes a first driving mode for use when the print media is not label paper, and a second driving mode for when the print media is label paper.

13. The image forming apparatus of claim 12, wherein the second driving mode includes driving the image carrier a first distance sufficient to transfer an image formed thereon to a print media, and then drive the image carrier a further distance.

14. The image forming apparatus of claim 12, wherein the processing unit is further configured to count the cumulative number of print media having an adhesive surface printed in the image forming apparatus; and
drive the image carrier in the second driving mode when the cumulative number is equal to a preset number.

15. The image forming apparatus of claim 14, wherein the processing unit is configured to reset the count of the number of print media having an adhesive surface printed in the image forming apparatus after the image carrier drives in the second mode.

16. A method of image forming,
receiving instruction information capable of specifying a print media on which a visible image is to be formed;
determining driving information indicating a driving mode of an image carrier for carrying a developing agent thereon to be transferred onto the print media based on the instruction information; and
selectively further driving the image carrier after transferring the developing agent onto the print media.

17. The method according to claim 16, wherein the image carrier is further driven when the image on the image carrier is to be printed on a print media has an adhesive surface.

18. The method according to claim 16, further comprising:
counting the number of printed print media having an adhesive surface printed using the image carrier.

19. The method according to claim 18, further comprising cleaning the image carrier after a predetermined number of print media having an adhesive surface printed using the image carrier.

20. The method according to claim 16, further comprising adding developing agent to the image carrier after the image thereon is transferred to a print media.
